(19) United States
(12) Patent Application Publication
(10) Pub. No.: US 2001/0003504 A1
(43) Pub. Date: Jun. 14, 2001

(54) Illuminator for liquid crystal display apparatus

(76) Inventors: Takayuki Ishihara, Kyoto (JP); Masao Saito, Kyoto (JP)

Correspondence Address: Michael D. Bednarek, SHAW PITTMAN, 2300 N Street, N.W., Washington, DC, 20037-1138, US

(21) Appl. No.: 09/731,765

(22) Filed: Dec. 8, 2000

(30) Foreign Application Priority Data
Dec. 10, 1999 (JP) 11-351667

(51) Int. Cl. F21V 8/00

(52) U.S. Cl. 362/31; 362/555

(57) ABSTRACT

An illuminator includes a light source, and a light guide panel for guiding light from the light source to outside. The light guide panel is formed with a transparent electrode. The light source is an LED chip having an electrode held in direct electrical contact with the transparent electrode.

### BACKGROUND OF THE INVENTION

1. Field of the Invention

The present invention relates to an illuminator for use in a liquid crystal display apparatus as a back lighter or a front lighter. It also relates to a liquid crystal display apparatus incorporating such a illuminator.

2. Description of the Related Art

A prior-art illuminator for use in a liquid crystal display apparatus is disclosed in JP-A-10-188636 for example. As shown in FIG. 6 of the accompanying drawings, the illuminator comprises a point light source 3e comprising an LED lamp for example and a light guide panel 9 made of a transparent material. The light guide panel 9 has an obverse surface 9a, a reverse surface 9b which is formed with a plurality of columnar protrusions 90, and an edge surface 91. The light source 3e is disposed beside the light guide panel 9 so as to face the edge surface 91.

With such an illuminator, when light from the light source 3e enters the light guide panel 9 through the edge surface 91, the light travels within the light guide panel 9 while being repetitively reflected by the obverse and the reverse surfaces 9a, 9b. During such travel, when the light becomes incident on any one of the protrusions 90, the light passes through the protrusion 90 to the outside. Thus, the reverse surface 9b of the light guide panel 9 serves as a light emitting surface for irradiating a surface of an object 99 such as a liquid crystal panel.

The use of the point light source 3e contributes to size reduction of the illuminator because it requires only a small mounting space as compared with a linear light source such as a cold cathode ray tube. However, the point light source 3e generally comprises an LED lamp. Since such an LED lamp comprises an LED chip which is connected to leads by wire-bonding and entirely sealed in a transparent resin, the LED lamp is larger than a naked LED chip. Although a midget lamp may be used as a light source, it is also larger than a bare LED chip. Therefore, a liquid crystal display apparatus incorporating such an illuminator can not be satisfactorily reduced in size, because size reduction of the light source is insufficient. Recently, in a liquid crystal display apparatus for use in a watch or a mobile phone for example, size reduction of the overall apparatus is demanded without reducing the size of the display apparatus. However, the prior art described above cannot meet such requirement.

To solve the problem described above, the inventors of the present invention have previously conceived the idea of embedding an LED chip in a light guide panel, as disclosed in JP-A-9-237514. With such a structure, a space for mounting a light source need not be provided outside the light guide panel, which leads to reduction in size and thickness of the illuminator. However, manufacture of such a light guide panel is troublesome because it involves the steps of mounting an LED chip on a predetermined frame and sealing the LED chip and the frame in resin.

### SUMMARY OF THE INVENTION

It is therefore an object of the present invention to provide an illuminator in which a light source is disposed in a space-efficient manner for realizing size and thickness reduction.

Another object of the present invention is to provide a liquid crystal display apparatus incorporating such an illuminator.

In accordance with a first aspect of the present invention, there is provided an illuminator which comprises a light source, and a light guide panel for guiding light from the light source to outside. The light guide panel is formed with a transparent electrode. The light source comprises an LED chip having an electrode held in direct electrical contact with the transparent electrode.

The illuminator having the above-described structure has the following advantages.

Firstly, the LED chip in its naked state is usable as a light source. Therefore, the light source is smaller than a conventional light source such as an LED lamp provided by resin-packaging an LED chip. As a result, only a small mounting space is needed for disposing the light source in facing relationship to the light guide panel, which leads to reduction in size and thickness of the illuminator.

Secondly, the cost for manufacturing a naked LED chip is lower than the cost for manufacturing an LED lamp. Further, unlike the prior art disclosed in JP-A-9-237514, the LED chip need not be embedded in the light guide panel. Therefore, the light guide panel can be manufactured easily, which also reduces the cost for manufacturing the illuminator.

In the third place, since the electrode of the LED chip is held in direct electrical contact with the transparent electrode provided on the light guide panel, no wire-bonding is need for supplying electric power to the LED chip.

In the fourth place, since the LED chip is held in direct contact with the transparent electrode of the light guide panel, it is possible to reduce the thickness of the illuminator.

In the fifth place, since light emitted from the LED chip enters the light guide panel immediately through the transparent electrode, it is possible to guide a large amount of light into the light guide panel.

Preferably, the light guide panel may include a planer surface, an irregular surface opposite to the planer surface, and an edge surface located between the planer surface and the irregular surface.

In one embodiment, the transparent electrode is formed on the planer surface of the light guide panel in direct contact with the electrode of the LED chip adjacent to the edge surface. Preferably, the transparent electrode may extend from the planer surface of the light guide panel onto the edge surface.

In another embodiment, the transparent electrode is formed on the irregular surface of the light guide panel in direct contact with the electrode of the LED chip adjacent to the edge surface.

In a further embodiment, the light guide panel includes an edge surface on which the transparent electrode is formed in direct contact with the electrode of the LED chip.

In accordance with a second aspect of the present invention, there is provided a liquid crystal display apparatus which comprises a substrate, a light source mounted on the substrate, a liquid crystal panel arranged above the substrate, and a light guide panel for guiding light from the light source to the liquid crystal panel. The light guide panel is formed with a transparent electrode. The light source comprises an LED chip having an electrode held in direct electrical contact with the transparent electrode.

Preferably, the light guide panel includes a planer surface, an irregular surface opposite to the planer surface, and an edge surface located between the planer surface and the irregular surface.

In one embodiment, the liquid crystal panel is disposed between the substrate and the light guide panel, and the transparent electrode is formed on the planer surface of the light guide panel in direct contact with the electrode of the LED chip adjacent to the edge surface. The LED chip may be disposed beside the liquid crystal panel between the substrate and the light guide panel. Preferably, the liquid crystal panel may include a reflective plate on a side of the liquid crystal panel away from the light guide plate. Further, the transparent electrode may preferably extend from the planer surface of the light guide plate onto the edge surface.

In another embodiment, the light guide panel is disposed between the substrate and the liquid crystal panel, and the transparent electrode is formed on the irregular surface of the light guide plate in direct contact with the electrode of the LED chip adjacent to the edge surface. Again, the LED chip may be disposed between the substrate and the light guide panel. Preferably, the liquid crystal panel may include a semi-pervious reflective plate on a side of the liquid crystal panel facing the light guide plate.

Preferably, the light guide panel may include an inclined surface formed at a first edge of the light guide panel in contact with a reflector for reflecting light from the LED chip toward a second edge of the light guide panel opposite to the first edge.

In a further embodiment, the light guide panel includes an edge surface on which the transparent electrode is formed in direct contact with the electrode of the LED chip.

Other features and advantages of the present invention will become clearer from the detailed description given below with reference to the accompanying drawings.

### BRIEF DESCRIPTION OF THE DRAWINGS

FIG. 1 is a sectional view showing a liquid crystal display apparatus embodying the present invention.

FIG. 2 is a sectional view showing a principal portion of a liquid crystal panel used in the liquid crystal display apparatus shown in FIG. 1.

FIG. 3 is a sectional view showing another liquid crystal display apparatus embodying the present invention.

FIG. 4 is a sectional view showing a principal portion of a liquid crystal panel used in the liquid crystal display apparatus shown in FIG. 3.

FIG. 5 illustrates a further liquid crystal display apparatus embodying the present invention.

FIG. 6 illustrates a prior-art illuminator for a liquid crystal display apparatus.

FIG. 7 illustrates an LED which is wire-bonded.

### DETAILED DESCRIPTION OF THE PREFERRED EMBODIMENTS

Preferred embodiments of the present invention will be described below in detail with reference to the accompanying drawings.

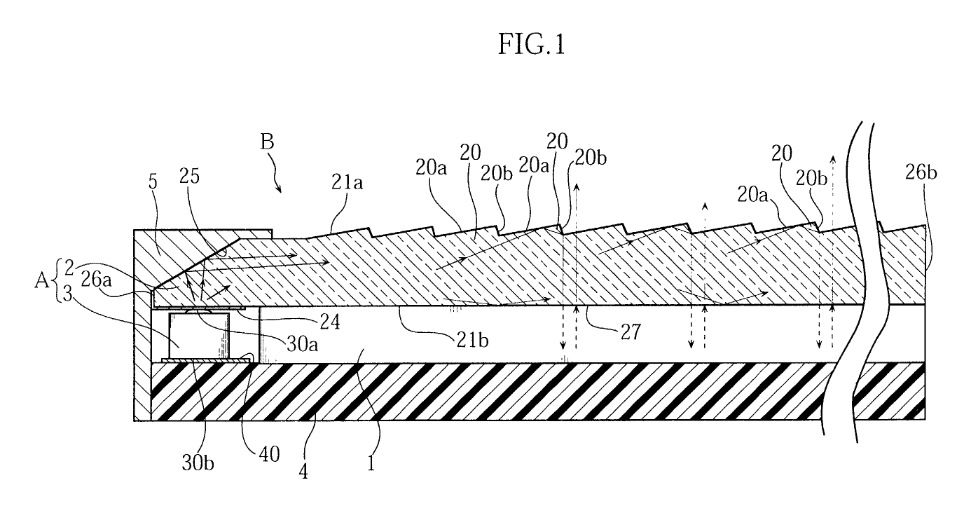

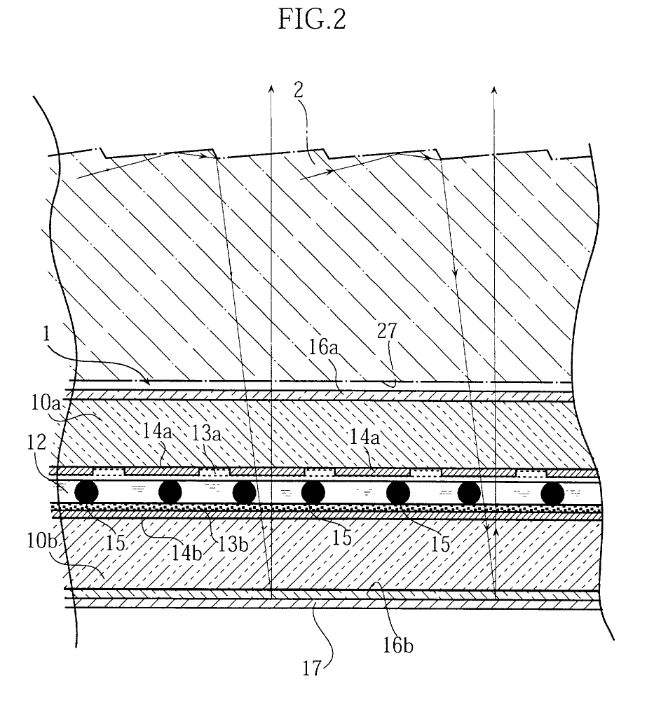

FIGS. 1 and 2 illustrate a liquid crystal display apparatus in accordance with a first embodiment of the present invention. In this embodiment, the present invention is applied to a front-lighting-type reflective liquid crystal display apparatus.

As shown in FIG. 1, the illustrated liquid crystal display apparatus B mainly comprises an illuminator A, a liquid crystal panel 1, a substrate 4, and a reflector 5. The illuminator includes a light guide panel 2 and an LED chip 3.

The substrate 4 may be formed of epoxy resin for example. The substrate 4 has an inner surface provided with a terminal 40 at one side thereof.

The LED chip 3 is in the form of a generally rectangular parallelepiped. The LED chip 3 has an obverse surface provided with a first electrode 30a and a reverse surface provided with a second electrode 30b. The LED chip 3 is mounted on the substrate 4 with the second electrode 30b held in direct electrical contact with the terminal 40. The obverse surface of the LED chip 3 serves as a light emitting surface.

The liquid crystal panel 1 is mounted on the substrate 4 beside the LED chip 3. The liquid crystal panel 1 is a thin panel having a thickness substantially equal to the height of the LED chip 3. As shown in FIG. 2, the liquid crystal panel 1 includes a pair of thin transparent films 10a, 10b. Liquid crystal is filled between the films 10a and 10b. The films 10a, 10b are internally formed with transparent electrodes 14a, 14b, respectively, and alignment layers 13a, 13b, respectively. A plurality of particulate spacers 15 are disposed between the alignment layers 13a, 13b to keep the distance between the films 10a and 10b. The films 10a, 10b are externally formed with polarizer plates 16a, 16b, respectively. A reflective film 17 is formed on the polarizer plate 16b.

The light guide panel 2 may be formed by molding a transparent resin such as polycarbonate or PMMA (polymethyl methacrylate) into a plate. As shown in FIG. 1, the light guide panel 2 includes an outer surface 21a, an inner surface 21b, an opposite pair of edge surfaces 26a, 26b. The light guide panel 2 further includes an inclined surface 25 for transition from the outer surface 21a to the edge surface 26a. The inclined surface 25 is located above the LED chip 3. The inner surface 21b of the light guide panel 2 serves as a light emitting surface 27. The light guide panel 2 is formed, at an edge thereof, with a transparent electrode 24. The electrode 24 may be formed of an ITO (Indium Tin Oxide) film and extends from the inner surface 21b up to the edge surface 26a of the light guide panel 2. The light guide panel 2 is mounted on the liquid crystal panel 1 and the LED chip 3 with the transparent electrode 24 held in direct contact with the electrode 30a of the LED chip 3 for electrical connection. Thus, light emitted from the LED chip 3 passes through the transparent electrode 24 for entering the light guide panel 2. For ensuring good contact between the transparent electrode 24 and the electrode 30a, the portion around the contact may be sealed with resin. The LED chip 3 may be entirely sealed in resin for protection.

The reflector 5 is provided to cover the edge surface 26a and the inclined surface 25 of the light guide panel 2, so that light from the LED chip 3 is prevented from leaking to the outside through such surfaces. The reflector 5 also covers an edge surface of the substrate 4. The portion of the transparent electrode 24 formed on the edge surface 26 of the light guide panel 2 is kept in intimate contact with the reflector 5. The reflector 5 is formed with a wiring pattern (not shown) in electrical connection to the transparent electrode 24 as well as another wiring pattern (not shown) formed on the inner surface of the substrate 4. As a result, electricity for driving the LED chip 3 can be supplied to the paired electrodes 30a, 30b via the non-illustrated wiring patterns, the transparent electrode 24 and the terminal 40.

The outer surface 21a of the light guide panel 2 is rendered non-planer. Specifically, the outer surface 21a is formed with a plurality of protrusions 20 arranged at a constant pitch of 100˜200 μm for example. Each of the protrusions 20 extends widthwise of the light guide panel 2 (perpendicular to the sheet surface of FIG. 1) and is triangular in cross section including two inclined surfaces 20a, 20b. The inner surface 21b of the light guide panel 2 is smoothly flat to provide the light emitting surface 27 for emitting light toward the liquid crystal panel 1.

With the above-described structure, light emitted from the LED chip 3 and entering the light guide panel 2 is totally reflected by the inclined surface 25 to travel within the light guide panel 2 toward the remote edge surface 26b while being repetitively reflected by the inner and outer surfaces 21a, 21b of the light guide panel 2. During such travel, when the light is incident on any of the inclined surfaces 20a, the incidence angle tends to be larger than the critical angle determined by the refractive index of the light guide panel 2 due to the fact that the surface 20a is inclined. Therefore, the light is likely to be totally reflected by the inclined surface 20a, thereby reducing the possibility of unexpected light leakage through the inclined surface 20a. On the other hand, when light is incident on any of the inclined surfaces 20b, the light is reflected thereon to become incident on the inner surface 21b at an incident angle smaller than the critical angle. Therefore, the light positively passes through the inner surface 21b (light emitting surface 27) without being reflected, thereby realizing effective light emission.

With the liquid crystal display apparatus B having the structure described above, the LED chip 3 employed as the light source of the illuminator A is relatively small-sized. Therefore, the LED chip 3 requires only a small mounting space, which leads to a reduction in size and thickness of the liquid crystal display apparatus B.

Further, since the LED chip 3 is disposed beside the liquid crystal panel 1 to utilize a small excess space between the light guide panel 2 and the substrate 4, the thickness of the liquid crystal display apparatus is not increased by the provision of the LED chip 3. Thus, the thickness of the liquid crystal display apparatus B may be kept small.

Moreover, since the electrode 30a of the LED chip 3 is held in direct contact with the transparent electrode 24 of the light guide panel 2 for electric conduction, wire-bonding for the electrode 30a is not necessary. If, as shown in FIG. 7, such wire-bonding is necessary, the space H for extending the wire W above the LED chip 3 increases the thickness of the liquid crystal display apparatus, whereas the space S for extending the wire laterally of the LED chip 3 increases the length or width of the display apparatus. According to the present invention, by contrast, such a wire-bonding space is unnecessary, thus contributing to a size reduction of the liquid crystal display apparatus B.

For image display, the liquid crystal display apparatus B operates basically in the same way as a conventional reflective liquid crystal display apparatus of the front-lighting type. Briefly, when light from the LED chip 3 is emitted from the light emitting surface 27 of the light guide panel 2 to enter the liquid crystal panel 1, the light travels downwardly within the liquid crystal panel 1 and then reflected upwardly by the reflective film 17, as shown in FIG. 2. As a result, the light travels upwardly through the liquid crystal panel 1 and the light guide panel 2 for emission to the outside, thereby enabling viewing of the image of the display apparatus from the front side.

Alternatively, if the LED chip is not turned on, light from the outside may be utilized for image display. In this case, external light entering, via the light guide panel 2, into the liquid crystal panel 1 travels downwardly and reflected on the reflective film 17. Then, the light travels upwardly through the liquid crystal panel 1 and the light guide panel 2 for emission to the outside.

In this way, whether light from the illuminator A or external natural light is utilized, the light traveling through the liquid crystal panel 1 can be efficiently reflected on the reflective film 17 toward the front side, thereby positively illuminating the liquid crystal display apparatus.

The transparent electrode 24 provides only little loss of light upon passage therethrough. Further, since the light emitting surface of the LED chip 3 is located very close to the light guide panel 2 due to contact between the transparent electrode 24 and the electrode 30a of the LED chip 3, light from the LED chip 3 enters the light guide panel 2 with high efficiency. Therefore, the amount of light guided into the liquid crystal panel 1 through the light guide panel 2 can be increased.

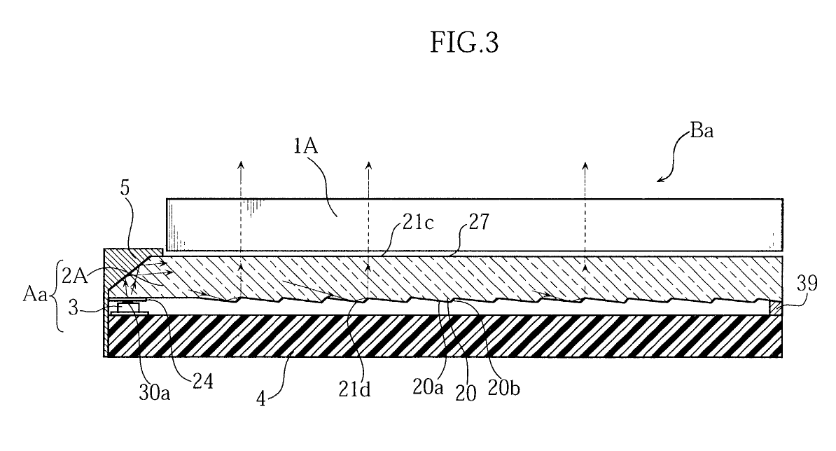

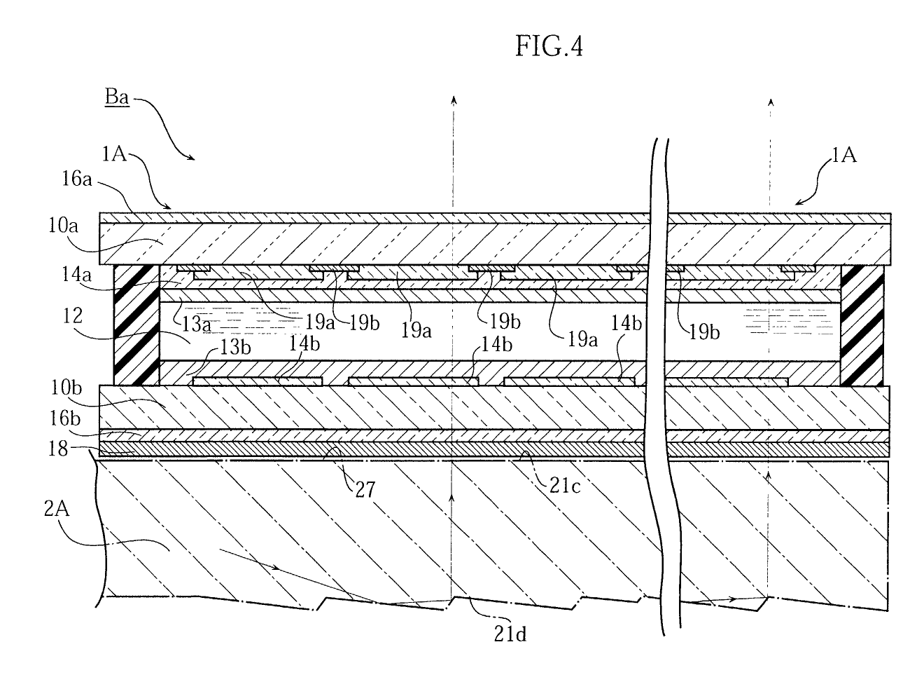

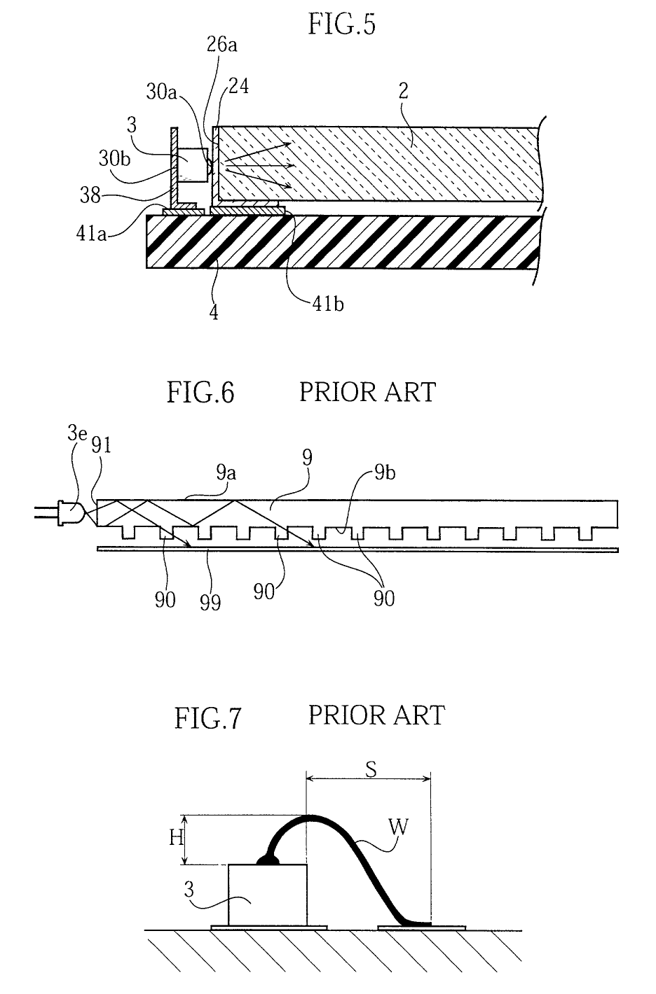

FIGS. 3 and 4 illustrate a second embodiment of the present invention. In FIG. 3 and the subsequent figures, the elements identical or similar to those of the first embodiment are designated by the same reference signs. In this embodiment, the present invention is applied to a semi-pervious type liquid crystal display apparatus of the back-lighting type.

As shown in FIG. 3, the liquid crystal display apparatus Ba of the second embodiment comprises an illuminator Aa, a substrate 4 and a liquid crystal panel 1A. The illuminator Aa includes an LED chip 3, and a light guide panel 2A arranged between the substrate 4 and the liquid crystal panel 1A.

The light guide panel 2A includes an inner surface 21d which is rendered irregular, and a planer outer surface 21c serving as a light emitting surface 27 for emitting light toward the liquid crystal panel 1A. Thus, in the second embodiment, the light emitting direction is opposite to that of the first embodiment.

As shown in FIG. 4, the liquid crystal panel 1A includes a semi-pervious reflective film 18, and a pair of transparent plates 10a, 10b made of glass material for sealing liquid crystal 12. Similarly to the first embodiment, each of the transparent plates 10a, 10b may be in the form of a thin transparent film. Between the transparent plates 10a and 10b, color filters 19 (R: red, G: green, B: blue) and black matrices 19b are provided for enabling color image display. However, the color filters may be dispensed with to perform monochromatic image display, as in the first embodiment.

As shown in FIG. 3, the inner surface 21d of the light guide panel 2A is provided with a transparent electrode 24. The light guide panel 2A is mounted on the substrate 4 with the transparent electrode 24 held into direct contact with an electrode 30a of an LED chip 3. A spacer 39 is provided to keep suitable spacing between the substrate 4 and the light guide plate 2A.

In the liquid crystal display apparatus Ba, light from the LED chip 3 travels through the light guide panel 2 and is emitted upwardly through the light emitting surface 27, as shown in FIGS. 3 and 4. Then, the light passes through the semi-pervious reflective film 18 to enter the liquid crystal panel 1A and then emitted to the front side of the liquid crystal panel 1A.

In the case where light from the LED chip 3 is not utilized, external light entering from the front side travels within the liquid crystal panel 1A. Then, the light is reflected on the semi-pervious reflective film 18 to be emitted to the front side of the liquid crystal panel 1A.

In this way, similarly to the first embodiment, the liquid crystal display apparatus according to the second embodiment is capable of performing image display both utilizing the illuminator Aa and external light.

The structure of the illuminator Aa in the second embodiment is basically similar to that of the illuminator A according to the first embodiment. Therefore, also in the second embodiment, a relatively small space will suffice for mounting the LED chip 3, which leads to reduction in size and thickness of the liquid crystal display apparatus.

FIG. 5 illustrates a third embodiment of the present invention. In this embodiment, a substrate 4 has an inner surface which is provided with terminals 41a, 41b. A light guide panel 2 is mounted on the substrate 4. The light guide panel 2 has an edge surface 26a which is provided with a transparent electrode 24. The transparent electrode 24 extends onto an inner surface of the light guide plate 2 so as to partially cover the inner surface. The transparent electrode 24 on the inner surface of the light guide panel 2 is electrically connected to the terminal 41b of the substrate 4. An LED chip 3 having electrodes 30a, 30b is disposed beside the light guide panel 2 with the electrode 30a held in direct contact with the transparent electrode 24 at the edge surface 26a of the light guide panel 2. The LED chip 3 is carried on a conductive support 38 with the electrode 30b kept in contact with the support 38 for electric conduction. The support 38 is electrically connected to the terminal 41a of the substrate 4.

With the structure described above, electricity can be supplied to the LED chip 3 via the terminals 41a, 41b of the substrate 4. Light emitted from the LED chip 3 enters the light guide panel 2 through the edge surface 26a to be appropriately emitted from a predetermined light emitting surface of the light guide panel 2. Provision of the LED chip 3 beside the light guide plate 2 is advantageous in reducing the thickness of the illuminator or the liquid crystal display apparatus as a whole.

The surface of the light guide panel which faces an LED chip is not limitative on the present invention. It is only necessary that a transparent electrode is provided at some selected portion of the light guide panel and held in direct contact with at least one electrode of the LED chip.

The present invention is not limited to the embodiments described above, and the specific structure of each element may be modified in various ways.

For example, although a single LED chip is provided in the foregoing embodiments, a plurality of LED chips may be provided. Further, a light guide panel having another configuration may be employed in the present invention. For example, it is possible to employ a conventional light guide panel provided with a plurality of cylindrical protrusions on one surface thereof. The illuminator according to the present invention may be used not only in a liquid crystal display apparatus but also in any apparatus which needs surface illumination. The color of light emitted by the LED chip is not limitative. The present invention may be applicable to any type of liquid crystal display apparatus such as a back-lighting type liquid crystal display apparatus without a semi-pervious reflective film.

1. An illuminator comprising:
a light source; and
a light guide panel for guiding light from the light source to outside, the light guide panel being formed with a transparent electrode;
wherein the light source comprises an LED chip having an electrode held in direct electrical contact with the transparent electrode.

2. The illuminator according to claim 1, wherein the light guide panel includes a planer surface, an irregular surface opposite to the planer surface, and an edge surface located between the planer surface and the irregular surface.

3. The illuminator according to claim 2, wherein the transparent electrode is formed on the planer surface of the light guide panel in direct contact with the electrode of the LED chip adjacent to the edge surface.

4. The illuminator according to claim 3, wherein the transparent electrode extends from the planer surface of the light guide panel onto the edge surface.

5. The illuminator according to claim 2, wherein the transparent electrode is formed on the irregular surface of the light guide panel in direct contact with the electrode of the LED chip adjacent to the edge surface.

6. The illuminator according to claim 1, wherein the light guide panel includes an edge surface on which the transparent electrode is formed in direct contact with the electrode of the LED chip.

7. A liquid crystal display apparatus comprising:
a substrate;
a light source mounted on the substrate;
a liquid crystal panel arranged above the substrate; and
a light guide panel for guiding light from the light source to the liquid crystal panel, the light guide panel being formed with a transparent electrode;
wherein the light source comprises an LED chip having an electrode held in direct electrical contact with the transparent electrode.

8. The liquid crystal display apparatus according to claim 7, wherein the light guide panel includes a planer surface, an irregular surface opposite to the planer surface, and an edge surface located between the planer surface and the irregular surface.

9. The liquid crystal display apparatus according to claim 8, wherein the liquid crystal panel is disposed between the substrate and the light guide panel, the transparent electrode being formed on the planer surface of the light guide panel in direct contact with the electrode of the LED chip adjacent to the edge surface, the LED chip being disposed beside the liquid crystal panel between the substrate and the light guide panel.

10. The liquid crystal display apparatus according to claim 9, wherein the liquid crystal panel includes a reflective plate on a side of the liquid crystal panel away from the light guide plate.

11. The liquid crystal display apparatus according to claim 9, wherein the transparent electrode extends from the planer surface of the light guide plate onto the edge surface.

12. The liquid crystal display apparatus according to claim 8, wherein the light guide panel is disposed between the substrate and the liquid crystal panel, the transparent electrode being formed on the irregular surface of the light guide plate in direct contact with the electrode of the LED chip adjacent to the edge surface, the LED chip being disposed between the substrate and the light guide panel.

13. The liquid crystal display apparatus according to claim 12, wherein the liquid crystal panel includes a semi-pervious reflective plate on a side of the liquid crystal panel facing the light guide plate.

14. The liquid crystal display apparatus according to claim 7, wherein the light guide panel includes an inclined surface formed at a first edge of the light guide panel in contact with a reflector for reflecting light from the LED chip toward a second edge of the light guide panel opposite to the first edge.

15. The liquid crystal display apparatus according to claim 7, wherein the light guide panel includes an edge surface on which the transparent electrode is formed in direct contact with the electrode of the LED chip.
